(19) United States
(12) Patent Application Publication
(10) Pub. No.: US 2014/0279407 A1
(43) Pub. Date: Sep. 18, 2014

(54) Incentive Banking System And Method

(71) Applicant: BANK OF AMERICA CORPORATION, Charlotte, NC (US)

(72) Inventors: James E. Burgess, Charlotte, NC (US); Alicia C. Jones, Fort Mill, SC (US)

(73) Assignee: BANK OF AMERICA CORPORATION, Charlotte, NC (US)

(21) Appl. No.: 13/800,571

(22) Filed: Mar. 13, 2013

(51) Int. Cl. G06Q 40/02

(52) U.S. Cl. CPC G06Q 40/02; G06Q 30/0215
USPC 705/39

(57) ABSTRACT

A method of transactional savings is described. A method may include electronically maintaining a plurality of transactional saving accounts for customers associated with a financial entity; electronically, receiving data representative of an upper limit monetary fund amount, a periodic monetary fund amount, and a risk-based incentive monetary fund amount associated with the transactional saving accounts. A method may include electronically maintaining a collective saving account associated the plurality of customers and receiving a total amount of monetary funds associated with a deposit transaction for at least one of the transactional saving accounts and distributing funds based on the amount in the collective saving account.

### BACKGROUND

Customer retention is an ideal goal of most businesses. In addition, attracting new customers is a constant mission of most businesses. As part of the process for meeting those goals, businesses develop new products and services. In certain industries, such as the financial services industry, development and implementation of new products and services for customers and potential customers is an ongoing process. Certain industries lend themselves to customers being drawn to outside factors, such as the environment, the economy, and/or the personal matters in making decisions about where to do their business.

There exists a need in the art for new customer incentive products and packages that assist businesses in maintaining existing customers and growing a base of new customers.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure are directed to a method and system for transactional savings. Aspects of the present disclosure describe a transactional savings and service or product that assist an individual or groups of individuals that has an account or accounts with a financial entity. In one aspect, an online or mobile banking patron or account holder may create one or more budgets that the user desires to save for various goals. In one aspect, a method includes electronically maintaining a plurality of transactional saving accounts for customers associated with a financial entity; electronically, receiving data representative of an upper limit monetary fund amount, a periodic monetary fund amount, and a risk-based incentive monetary fund amount associated with the transactional saving accounts.

In one aspect, a method may include electronically maintaining a collective saving account associated the plurality of customers and receiving a total amount of monetary funds associated with a deposit transaction for at least one of the transactional saving accounts.

In one aspect, a method may include steps of determining whether the total amount of monetary funds received, matches or exceeds the periodic monetary amount. In one aspect, the method may identify a first portion and a second portion of the total amount of monetary funds associated with the deposit transaction, the first portion can be the incentive amount of monetary funds and the second portion can be the incentive amount less than the total amount of the monetary funds received.

In one aspect, the method may include steps of electronically applying the first portion to the collective saving account and applying the second portion to the least one transactional saving account and receiving data representative of an event associated with the collective saving account; and a step of electronically distributing the total amount of monetary funds in the collective saving account to the transactional saving accounts of the customers based on the event.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an example graphical user interface display for implementing an application tool processing and functions of certain embodiments of the present disclosure;

FIG. 4 is an example of a graphical chart showing the tracking progress of the monetary funds and saving account objective;

FIG. 5 is an illustrative functional block diagram of workstations and servers that may be used to implement the processes and functions of certain embodiments; and

FIG. 6 is an example flow chart of an illustrative method for in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, mobile computing devices, e.g., smart phones, wearable computing devices, tablets, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The methods and features recited herein further may be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

FIG. 3 is an example graphical user interface (GUI) for implementing an application tool processing and functions of certain embodiments in the present disclosure. As understood by those skilled in the art, the graphical features in FIG. 3 may be implemented by one or more of the components in FIGS. 1 and 2 and/or other components, including other computing devices.

Referring to FIG. 3, aspects of the present disclosure describe a transactional savings and service or product that assist an individual or groups of individuals that has an account or account with a financial entity. In one aspect, an online or mobile banking patron or account holder may create one or more budgets that the user desires to save for various goals. The inventive banking application tool may presents the patron/user with a computer-based page 300, such as a graphical user interface (GUI) implemented on display screen of a computing device. In one aspect, the application tool presents a graphical object bar 301 categories of data items presented to the patron. The horizontal graphical object bar 301 may include categories such as a Budget Name 302, Budget Amount 304, Expire Date 306, Percentage Completed 308, Weekly Saving 310, and Amount Paid 312.

Aspects of the present disclosure may be implemented with respect to any of a number of financial products or services, including, but not limited to, a credit card, a home equity loan, an automobile or other vehicle, such as a motorcycle, a boat, or an all terrain vehicle, a payment plan, and a mortgage. In addition, aspects of the present disclosure may be included with other existing products or services of a business. The tool enables the patron to create a plurality of patron designated saving account budgets 314 and 316, such as for example, budget objectives named “Vacation” and “Holiday”. These accounts budgets could be anything the user desires to create a transactional saving account for end-use purchasing transaction or series of end-use associated transactions such as, a future vacation, automobile, college education program, real-estate, business equipment, consumer product, or consumer service. Optionally, the GUI web page can present the saving account budgets 314 and 316 under a “My Budgets” tab when activated by a patron by a click-through action commanding or controlling the functionality of a software program or a computer implemented with an input/output device, such as a pointing device.

In one aspect, the application tool enables the patron to set the upper limit of saving objective as represented in the GUI page on object bar 301, category 304. In one aspect, the application tool enables the patron to set how much they want to save on a periodic basis, such as daily, weekly, biweekly, monthly or keyed to a periodic or temporal triggering event according to budget goals. Optionally, the application tool can automatically calculate how much the patron will need to save for periodic occurrence, such as each week or month, in order to reach the savings objective. The feature of periodic saving is associated in the GUI page on object bar 301, category 310. Additionally, the application tool enables the patron to establish a time period to reach the saving objectives and the date or dates that the patron wants to achieve these goals. The action of establishing a time period is associated in the GUI page on object bar 300, category 306. If desired, the application tool can calculate the percentage of the amount of the saving budget completed as shown by graphical object bar 301, category 308. The percentage complete may be based on a number of different criteria. In one example, the percentage completed is calculated by the total amount of monetary funds in the saving account budget 314 and 316 divided by the upper limited of the goal. For example, in saving account objective 314 the goal shows $9,000 and the percentage complete is 85%.

As shown in FIG. 3, the incentive banking application tool may present a “view” progress graphical object 318, such as rectangular shape object, in line with the saving account budget. The patron will be able to see some statistics of their usage and performance to date in reaching the saving account objective. Referring to FIG. 4, the application tool enables the patron to check their progress towards their goals via a click-through action on object 318 thereby commanding or controlling the functionality of application tool software implemented with an input/output device, such as a pointing device. In FIG. 4, there is shown a graphical snapshot of a graph 400 that shows the patron's saving account predetermined budget per month 402, and the patron's progress towards their budgeted objective 404. In the example of FIG. 4, the graphical display for the budgeted amount per month 402 is shown in an upward straight line designated by a line equation that the slope is determined by the periodic amount. And the non-linear line 404 is representative of the amount of monetary funds inputted by the patron.

In one aspect, the application tool enables the patron to establish various stakes or how much the patron is willingly to risk if the monetary fund saving objective is not reached per account. The various stakes or risks may be associated with a financial product or service of a financial entity. For example, a patron may establish a saving account budget for an initial payment of home or automobile. The patron may set-up a monthly periodic amount to saving, such as a monthly basis. As an incentive for the patron of saving towards their goal, the application tool may present the patron with a menu or listing options for a particular financial product or service associated with financing of the end-item or end-use of the saving account objective for a transaction. For example, in the automobile saving account objective, the patron is presented with different financing rate options of automobile loans for the end-transaction of purchasing an automobile. The patron may select the lowest rate option if they meet the saving goal objective. However, the patron may select a higher rate option is they do not make the ultimate objective. In one example, the application tool may suggest if the patron is saving $100 per month for an automobile, they may get a loan at 4.9%. If you save $125 per month, they may be able to obtain 3.9% rate. That is the more saved more the loan rate. In one example, the patron may select 3.1% A.P.R for a 5-year loan for one goal amount and a 3.5% A.P.R. loan of the same term, if the goal is not reached. The difference between the two rates (e.g., 0.40% A.P.R.) is the amount that the patron is receiving as a financial incentive to continue to save to meet the patron established goal. Hence, by meeting the ultimate goal, the patron may receive a lowest rate and the patron may be motivated to save more than simply have a non-incentive savings goal. As can be appreciated in one aspect, this type of incentive saving tool can be implemented to present patron with different A.P.R. rates for credit card accounts.

In one aspect, the application tool enables the patron to establish various stakes or how much the patron is willing to risk in a specific amount of monetary funds INCENTIVE_AMT, if the saving objective is not reached per the account. As shown in FIG. 5, in one aspect, the incentive banking application tool may be applied to a group individuals who are set-up to receive funds from a collective pooled monetary account. In such an example, the collective pooled monetary account may be stored within a memory/database, such as memory 115 and/or RAM 105 in FIG. 1. Referring to FIG. 5, the collective pooled account 500 is funded from the individual saving accounts 502, 504, 506 and 508 of the amount risked INCENTIVE_AMT, if any one of the patrons does not reach the goal for their particular patron account 1 through 4. The collective pooled account 500 may be established to stay active until the group goal is completed based on a temporal event, such as a date or time period. Individual members of the group can received a payout of the collective pooled account 500 based on equally divided shared of the total amount of momentary funds. The payout of the funds from the collective pooled account may be deposited in individual saving accounts 502, 504, 506 and 508 of the members of the collective account. In this way, members of the pool also can receive monetary funds to meet their goals as well. Examples of a group of individuals utilizing one or more aspects of the present disclosure described herein may include a family, such as a family of five, two parents and two children, and grandparents.

Referring back to FIG. 3 of the GUI page for the particular patron, the application tool can display activity statistics of the various data fields, including the amount of active budgets 320, the total amount earned 322, the amount of the incentive funds paid 324, the overall total of the incentive amount 326, and the aggregate total of the periodic saving 328. The value of the amount of active budgets 320 is calculated from the number transactional saving accounts operating for the patron. The value of the total amount earned 322 is the cumulative total of patron's divide share of monetary funds in the collective pool account 500. The value of the amount of the incentive funds paid 324 is calculated from the patron's payout of the incentive amounts. The value of the overall total of the incentive amount 326 is the aggregate total of the individual incentive amounts linked to the transactional saving accounts. The value of the aggregate total of the periodic saving 328 is the total value of the monetary funds per period promised to be deposited. In one example shown in FIG. 3, data field 320 has two active budgets; data field 322 shows $38.42 for the total amount earned; data field 324 shows $10.33 for the amount paid; data field 326 shows $28.09 for the overall incentive amount; and data field 328 shows $350 for a proposed weekly savings. In one or more aspects, the value of the data fields 320, 322, 324, 326, and 328 can be static based on a particular time period or dynamically updated when patron is viewing or otherwise accessing the GUI page 300 electronically on-line.

Any of a number of other examples of a group of individuals utilizing one or more aspects of the present disclosure described herein may be implemented. Yet other examples of a group of individuals utilizing one or more aspects of the present disclosure described herein may include friends utilizing an online social network. In the social aspect, the patron may want a group to be collectively to be successful. In this way, there can be interactively of social play of cheering each other on or sharing saving tips. The online social network may have an agreement with a financial entity for providing a service and/or product to participating users of the social network in accordance with one or more aspects described herein. A group of individuals, such as friends, that utilize the social network may utilize one or more aspects as described in the present disclosure that are offered through or by the social network. For example, the application tool may enable a patron to invite another person to the incentive saving challenge or the collective saving pool, and the other person could invite someone else to saving to the incentive banking system and into the collective saving pool. Hence, as more people join the group more savings dollars are invested. Additionally, the potential collective pool may be larger due to the incentive amount potentially deposited into the pool. In one alternative aspect, at the end of the saving goals, any funds in the collective pool instead of be divided among the participants, may have the total amount of the pooled funds provided to a third entity, such as a charitable organization.

In one aspect, if the person invited to join the collective pool does not have a saving account with the financial entity, the person may be offered an option to open an individual saving account or checking account with the financial entity to have access to the collective pool saving account. In this way, a new patron opens an account and then the application tool can show then how you can set a goal or participate in the saving challenges once the patron sets up that account.

In one aspect, the application tool is able to determine the potential products or service being saved for. In such as case, the application tool can customize other incentives from an end-product or end-user service perspective. The application tool can determine how many patrons fit a particular interest for purchasing a product. As a result, the patrons are more likely to actually make a purchase, because they actively saving funds. For example, if the application tool determines a group of patrons is saving for a flat screen TV product, the application tool can aggregate the collective group and search for a relationship vendor of flat screen TVs. In one aspect, the application tool present data to specialized offer, based on a threshold of a plurality of transactional saving account for customers/patrons of the financial entity or using the inventive banking application tool. In one example, if the tool determines there are 1,000 people who are saving for a flat screen TV, then tool can request a special pricing or promotional deal for those people who actually are saving. The promotional deal could be 25% off the television or other item can be provided to the patron. In this way, the application tool enables a financial entity or entity hosting the collective pool to provide additional incentive benefits to the patrons.

The steps that follow in the FIG. 6 may be implemented by one or more of the components in FIGS. 1 and 2 and/or other components, including other computing devices.

Returning to FIG. 6, the process starts and at step 601, saving account budget data representative of a plurality of accounts associated with a transactional savings program of an entity may be maintained. In such an example, the saving account budget data may be stored within a memory/database, such as memory 115 and/or RAM 105 in FIG. 1. As described above, any number of different types of saving account budget data may be designated. Proceeding to step 603, account data associated with the transactional savings program for a plurality of customers may be maintained in a computer readable database 121. The account data may be any number of categories, such as the monetary funds for the budget goal amounts, time period, periodic timing for receiving of saving deposit, monetary fund amount for the periodic deposit, and the incentive amount at risk. Again, in such an example, the separate account data may be stored within a memory/database, such as memory 115 and/or RAM 105 in FIG. 1.

In one example of Step 603, the application tool presents to the patron an option to create a budget to set your goals. And the tool may have a question “How much money you want to save for a particular idea or goal?” The patron may create a budget of $5,000 for a vacation and set a date of December 2016. In this step, after a goal amount, and end date is inputted by the patron, and then the application tool may calculate a monthly or weekly savings based on that patron data. In another example, if patron is saving for an automobile the financial entity may be able use this information data to assist the patron's ultimate goal. The application tool may suggest options, such as, by saving $1,000 for a down payment, the tool may suggest an automobile loan at one rate. Or the application tool may suggest to the patron that if they save $2,000 and put this amount down on a loan, then they might qualify for another rate. Further, the application tool may request from the patron to provide an incentive amount at risk. For example, the application tool may present an information request such as, “Please set stakes how much you're willing put aside in the collective pool if you don't meet your savings goal.” In this one example, the customer may decide if they do not make this month's goal, they may risk $10 as an incentive amount.

Proceeding to step 605, a plurality of accounts associated with the plurality of customers of the entity may be maintained. In such an example, data of the accounts may be stored within a memory/database, such as memory 115 and/or RAM 105 in FIG. 1. In 607, saving deposit data associated with a customer may be received. The saving deposit data is associated with monetary funds received from a customer for the particular saving account including the periodic deposit amount. In step 609, the application tool determines whether the predetermined the goal date or goal amount (e.g., a triggering event linked the accounts) has been reached. If the goal date or goal amount has been reached, the member may optionally receive an electronic message about reaching the goals, and the process moves forward to Step 611. In Step 611, the funds in the collective pooled account 500 is distributed to the members. In one aspect, because the collective pooled account 500 is divided among the participants, the member may receive a portion of their own incentive amounts contributed into the collective pooled account. They not receive exactly what they contributed because the incentive amount what placed at risk to be provided into the pooled account. In Step 615, the members may be given an option to transfer their share of the distributed funds to various accounts. If the goal date or goal amount has not been reached, the process moves forward to Step 617.

In Step 617, the application tool makes a determination whether the amount of the deposit of the customer meets to the predetermined deposit amount to reach the designated goal. In Step 617, if the deposit meets or exceeds the goal, then the process moves to Step 619. In Step 619, a congratulatory notification message may be sent to the patron/member for succeeding in the periodic deposit goal. The electronic notification message can be sent in any number of electronic communication methods and information technology, including by electronic mail, text message, automatic phone message or characters on a customer specific on-line banking page. Optionally, the application tool may present or offer the patron with a service or product by unlocking a deal. For one example, the application tool can review the deposit transactional history, and the intended goals for the end-purchase, and segment the deals to those patrons who actually meet goals. After the message, the process moves Step 607 to wait for another deposit by the patron.

In Step 617, the application tool determines whether the total amount of monetary funds received is less than the periodic deposit monetary amount. If the periodic deposit amount does not meet the predetermined deposit amount, the process move to Step 621. In Step 621, the application tool may provide suggestions to the patron to reach the saving account budget amount. The suggestions may be displayed on a GUI of a computing device. The suggestion made include ways to saving on monthly expenses or other ways to increase the saving goal. For example, a suggest might be if patron wants a 3.9% interest rate on a credit card account, they will need to save $1000 of dollars by a certain date.

The process move to step 623 in which the predetermined incentive amount is deposited in the collective pooled account of the group. In this step, the application tool may identify a first portion and a second portion of the total amount of monetary funds associated with the deposit transaction from Step 607. The first portion can be the incentive amount of monetary funds and the second portion can be the incentive amount less than the total amount of the monetary funds received. The first portion and the second portion are different amounts of monetary funds of the total amount of monetary funds deposited. Alternatively, incentive amount can be funded from the transactional saving account or other accounts of the patron, such as a checking account.

In Step 625, a notification may be transmitted to each of members of the collective pooled account via any number of electronic communication methods and information technology, including by electronic mail, text message, automatic phone message or characters on a customer specific on-line banking page. The application tool process ends in step 627.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present disclosure.

1. A method comprising:
electronically maintaining a plurality of transactional saving accounts for customers associated with a financial entity,
electronically, receiving data representative of an upper limit monetary fund amount, a periodic monetary fund amount, and a risk-based incentive monetary fund amount associated with the transactional saving accounts;
electronically maintaining a collective saving account associated the plurality of customers;
receiving a total amount of monetary funds associated with a deposit transaction for at least one of the transactional saving accounts;
determining whether the total amount of monetary funds received matches or exceeds the periodic monetary amount;
if the total amount of monetary funds received is less than the periodic monetary amount; then identifying a first portion and a second portion of the total amount of monetary funds associated with the deposit transaction, the first portion being the incentive amount of monetary funds and the second portion being the incentive amount less than the total amount of the monetary funds received, the first portion and the second portion being different monetary funds of the total amount of monetary funds;
electronically applying the first portion to the collective saving account and applying the second portion to the least one transactional saving account;
receiving data representative of an event associated with the collective saving account; and
electronically distributing the total amount of monetary funds in the collective saving account to the transactional saving accounts of the customers based on the event.

2. The method of claim 1, wherein if the total amount of monetary funds received matches or exceeds the periodic monetary amount, then electronically transmitting a congratulatory message to a device of a customer associated with the at least one transactional saving account.

3. The method of claim 1, wherein if the total amount of monetary funds received matches or exceeds the periodic monetary amount, then electronically transmitting an offer message associated with the at least one transactional saving account to a device of a customer associated with the at least one transactional saving account.

4. The method of claim 1, wherein responsive to the step of electronically, receiving data representative of an upper limit monetary fund amount, displaying on a graphical user interface a plurality of options associated with establishing the periodic monetary fund amount.

5. The method of claim 1, wherein responsive to a threshold of a plurality of transactional saving account for customers and the upper limited monetary fund amount, electronically presenting a plurality of unlocking transactional offers to customers associated with the plurality of transactional saving accounts.

6. The method of claim 5, wherein responsive to electronically applying the first portion to the collective saving account, electronically transmitting a notification message to customers. associated with the plurality of transactional saving accounts.

7. The method of claim 5, further comprising electronically presenting summary data associated with the plurality incentive monetary fund amounts applied to the collective saving account representative of the share earned associated with the customer of the plurality of transactional saving accounts.

8. The method of claim 1, wherein data representative of an event associated with the collective saving account comprises an expiration time period linked to transactional saving account.

9. The method of claim 1, further comprising electronically transmitting a message to establish a transactional saving account based data received from a customer with a pre-established transactional saving account.

10. One or more non-transitory computer readable media storing computer executable instructions that, when executed by at least one processor, cause the at least one processor to perform a method comprising:
electronically maintaining a plurality of transactional saving accounts for customers associated with a financial entity,
electronically, receiving data representative of an upper limit monetary fund amount, a periodic monetary fund amount, and a risk-based incentive monetary fund amount associated with the transactional saving accounts;
electronically maintaining a collective saving account associated the plurality of customers;
receiving a total amount of monetary funds associated with a deposit transaction for at least one of the transactional saving accounts;
determining whether the total amount of monetary funds received matches or exceeds the periodic monetary amount;
if the total amount of monetary funds received is less than the periodic monetary amount; then identifying a first portion and a second portion of the total amount of monetary funds associated with the deposit transaction, the first portion being the incentive amount of monetary funds and the second portion being the incentive amount less than the total amount of the monetary funds received, the first portion and the second portion being different monetary funds of the total amount of monetary funds;
electronically applying the first portion to the collective saving account and applying the second portion to the least one transactional saving account;
receiving data representative of an event associated with the collective saving account; and
electronically distributing the total amount of monetary funds in the collective saving account to the transactional saving accounts of the customers based on the event.

11. The one or more non-transitory computer readable media of claim 10, wherein if the total amount of monetary funds received matches or exceeds the periodic monetary amount, then electronically transmitting a congratulatory message to a device of a customer associated with the at least one transactional saving account.

12. The one or more non-transitory computer readable media of claim 10, wherein if the total amount of monetary funds received matches or exceeds the periodic monetary amount, then electronically transmitting an offer message associated with the at least one transactional saving account to a device of a customer associated with the at least one transactional saving account.

13. The one or more non-transitory computer readable media of claim 10, wherein responsive to the step of electronically, receiving data representative of an upper limit monetary fund amount, displaying on a graphical user interface a plurality of options associated with establishing the periodic monetary fund amount.

14. The one or more non-transitory computer readable media of claim 10, wherein responsive to a threshold of a plurality of transactional saving account for customers and the upper limited monetary fund amount, electronically presenting a plurality of unlocking transactional offers to customers associated with the plurality of transactional saving accounts.

15. The one or more non-transitory computer readable media claim 10, wherein responsive to electronically applying the first portion to the collective saving account, electronically transmitting a notification message to customers. associated with the plurality of transactional saving accounts.

16. The one or more non-transitory computer readable media claim 10, further comprising electronically presenting summary data associated with the plurality incentive monetary fund amounts applied to the collective saving account representative of the share earned associated with the customer of the plurality of transactional saving accounts.

17. The one or more non-transitory computer readable media of claim 10, wherein data representative of an event associated with the collective saving account comprises an expiration time period linked to transactional saving account.

18. The one or more non-transitory computer readable media claim 10, further comprising electronically transmitting a message to establish a transactional saving account based data received from a participant with pre-established transactional saving account.

19. A system comprising:
at least one database configured to maintain a plurality of transactional saving accounts for customers associated with a financial entity; and
at least one computing device, operatively connected to the at least one database, configured to:
receive data representative of an upper limit monetary fund amount, a periodic monetary fund amount, and a risk-based incentive monetary fund amount associated with the transactional saving accounts;
maintain a collective saving account associated the plurality of customers;
receive a total amount of monetary funds associated with a deposit transaction for at least one of the transactional saving accounts;
determine whether the total amount of monetary funds received matches or exceeds the periodic monetary amount;
if the total amount of monetary funds received is less than the periodic monetary amount; then identify a first portion and a second portion of the total amount of monetary funds associated with the deposit transaction, the first portion being the incentive amount of monetary funds and the second portion being the incentive amount less than the total amount of the monetary funds received, the first portion and the second portion being different monetary funds of the total amount of monetary funds;
apply the first portion to the collective saving account and applying the second portion to the least one transactional saving account;
receive data representative of an event associated with the collective saving account; and
distribute the total amount of monetary funds in the collective saving account to the transactional saving accounts of the customers based on the event.

20. The system of claim 1, the at least one computing device further configured to: display a plurality of options associated with establishing the periodic monetary fund amount responsive to the step of receiving data representative of an upper limit monetary fund amount.
